(19) United States
(12) Patent Application Publication
(10) Pub. No.: US 2010/0060412 A1
(43) Pub. Date: Mar. 11, 2010

(54) JSI automotive application: biometric vehicle electrical scanner

(75) Inventor: Linsley Anthony Johnson, Berkeley, CA (US)

Correspondence Address: Linsley A. Johnson, 2214 Channing Way #8, Berkeley, CA, 94704, US

(73) Assignee: Linsley Anthony Johnson, Berkeley, CA (US)

(21) Appl. No.: 12/583,207

(22) Filed: Aug. 17, 2009

Related U.S. Application Data
(60) Provisional application No. 61/191,041, filed on Sep. 8, 2008.

(51) Int. Cl. G06F 7/04

(52) U.S. Cl. 340/5.53

(57) ABSTRACT

JSI has developed a (1×3) biometric based USB multi-functional key that is designed to operate and control a vehicle ignition system by the electrical circuit channels of the vehicle's electrical systems. In the automotive application the JSI Key and its' (CRS) Chip Recognition System and the automotive track on the JSI Key works in conjunction with the Biometric Vehicle Electrical Scanner and Biometric Identification Surface Pads (BISP) this integrated biometric technology will eliminate vehicle theft and provide the owner with a designated driver function.

JSI has developed a (1×3) biometric based USB multi-functional key that is designed to operate and control a vehicle ignition system by the electrical circuit channels of the vehicle's electrical systems. In the automotive application the JSI Key and its' (CRS) Chip Recognition System (Application number -11-900-118) and the automotive track on the JSI Key works in conjunction with the Biometric Vehicle Electrical Scanner and Biometric Identification Surface Pads (BISP) this integrated biometric technology will reduce and eliminate vehicle theft and provide the owner with a designated driver function.

The automotive biometric electrical scanner can scan, read and store fingerprints from and to the JSI Key automotive track and into the vehicle's electrical system. Therefore, the prints on a JSI Key automotive track must always match the prints that are stored in the vehicle electrical system and when approved the designated person will have access and control of the vehicle. The JSI Key can provide automotive and designated driver access and the JSI Key owner can designate up to (2) drivers per vehicle that he/she owns. In this application (BISP) Biometric Identification Surface Pads are stored electronically in the vehicle, and the designated user can access the vehicle from the exterior door area using the Biometric Identification Surface Pads (BISP) or remote access.

JSI can provide the JSI Key Automotive application as a stand alone product with a duplicate JSI Key having up to 3 authorized driver which can be use in a commercial or large organizational environment. Just as the present market offer replacement keys or key for designated driver using the vehicle check out system.

After entering the vehicle, the JSI Key, working in conjunction with the ignition system, will let an authorized driver operate the vehicle. The JSI automotive application consist of a biometric scanner that is built into the surface side of the steering column and is (1×1) inch and (0.50) inch in depth and has a memory of (1) MB for the designated owner to scan their finger print or designated prints into the electrical system and on the JSI Key automotive track.

In the automotive track the JSI Key and the CRS-Chip Recognition System can electronically and automatically identify designated vehicles by the electrical current signals and vehicle security codes on the JSI Key in the automotive track similar to present day vehicles that are the same make and model but their keys are different. Whereas the present ignition systems and vehicles can allow theft; the JSI application prevents it because of the biometric requirement, the 10 second biometric security confirmation and the default application if the biometric system is turn off for any long period of time.

In the automotive track when the JSI Key is used for the first time the JSI Key will automatically default to Auto Track (i) where the owner's (e) fingerprint (s) are scanned and stored in the electrical system to provide access and control for that vehicle and the print (s) will be displayed in the vehicle control panel. From an operational and functional standpoint the (e) prints stored in the electrical system must always match the (e) prints stored on the JSI Key that is inserted into the ignition, if the prints do not match the vehicle will not start.

The JSI Key provides an additional security process which includes a 10 second biometric confirmation. After the vehicle has been started the designated driver is required place their place their finger on the scanner for an active match and if the scan print does not match the stored print in the electrical system the vehicle will stop.

The JSK Key owner can add or delete an (e) fingerprint (s) from the vehicle's electrical system and from the vehicle automotive track on the JSI Key at the same time. The primary owner's print will be in stored in the electrical system and on all three segments tracks of the automotive track on the JSI Key with room to add one driver per segment.

In each segment the JSI Key will have the primary driver plus one by combining this process with the 10 second confirmation prevent external theft.

Auto Track (2), if the JSI Key owner has a second driver that he/she authorize to drive his/her car once the JSI Key is inserted into the ignition the JSI Key will automatically default to Auto Track (2) and designated finger print (s) can be install in the vehicle electrical system for complete access and control of the vehicle. This process can be duplicated up to 2 designated drivers per vehicle using the JSI automotive application.

As a dual component the BIPS (Biometric Identification Surface Pads) and the JSI Key applications, working together, will protect the Key holder vehicle (s) from auto theft. This theft application can be turned on and off with a preset timer controlled by the clock. This feature was designed for short-term authorized drivers, such as valet parking attendants, auto mechanics or designated person.

### Manner and Process of Making

The JSI Automotive Biometric Scanner is a scaled down version of the biometric scanner that is used in the JSI applications which includes the point of sales application, automotive and (BISP) technology, and the entry access applications.

The Automotive Biometric/Fingerprint Scanner dimensions are (1×1) inch and (0.50) inch in dept the finger print scanner is integrated into steering column on the top side and the prints are scan into the vehicle's electrical system from the scanner and appears in the vehicle print confirmation panel as (D1) (D2) and (D3). See FIG. (2) Number 220

The JSI Biometric Electrical Scanner has a 1 MB of memory storage for retaining the owners' left or right index finger or his or her left or right thumbs for the biometric scanner to install his or her prints into the electrical system. The index fingers and thumbs will provide the most accurate biometric results. The print approval and driver indicator light or designated symbols are located in the automotive control panel in the print confirmation panel in the following (e) print order:

### Track (1) Driver One (D1)

### Track (2) Driver Two (D2)

### Track (3) Driver 3 (D3)

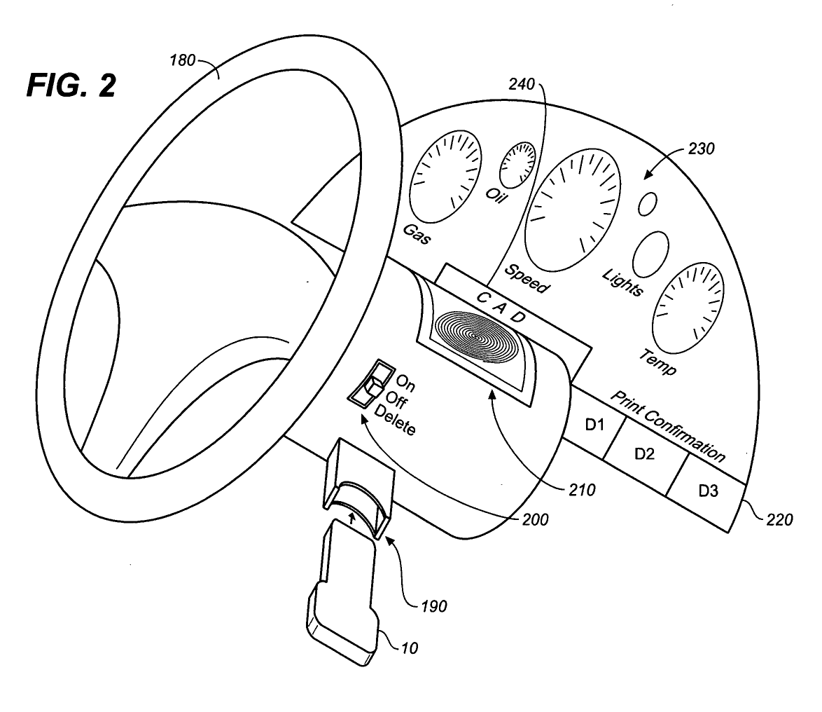

Below is a picture of the JSI Biometric Automotive scanner that is built into the surface area of the steering column and is connected into the vehicle electrical system. (FIG. 2)

### Internal

The JSI Biometric Automotive Scanner is integrated into the steering column is made in the following steps.
1. Small sheets of polyvinyl chloride acetated plastic that are molded in shape into a (1×1) dimension with an optical infrared Fingerprint Sensor.

### Memory: Flash Memory 1 MB

JSI-Biometric reader and scanning software

### Standard I/O Configurations

### Security: DES, 3DES, RSA, Master/Session, DUKPT

### Weight: 2 lbs

Connectivity: Hardware USB supported with cables.

### Enrollment Method Single Finger, Multi-Touch Enrollment

JSI Automotive Biometric Scanner: FIG. (2)

### External—(Outside the Vehicle)

### BISP—Size (1×1) Biometric Identification Surface Pad

Built into the exterior structure of the door are the (BISPs) providing the owner the option to use the BISP technology to access the car or vehicle using the scan print that is in the vehicle electrical system.

The (BISP) consist of a soft biometric sensory around door frame area, or the doors can open through a remote access.

### Using the Same

The JSI Automotive Application (BVES) Biometric Vehicle Electrical Scanner is designed to work in conjunction with the JSI Key in preventing auto thefts and determining who is authorize to drive the designated vehicle. Upon entering a designated vehicle that has the JSI automotive application the owner will take their JSI Key and insert it into the ignition if this a first time user the following steps are required to be taken.
1. The owner will insert their JSI Key into the vehicle ignition system.
2. The Chip Recognition System in the JSI Key will recognize the automotive electrical system and ask the user to install the designated driver (e) prints.
3. At that point the owner will take their left or right index finger or thumb and place it on the JSI infrared biometric scanner and the scanner will scan the print into the vehicle electrical system as (e) print (1) and that designated driver and that print will have access to the vehicle ignition system and the (BISP) Biometric Identification Surface Pads to access the vehicle doors. At the same time the biometric scanner will send a scanned copy of the print to the JSI Key and that print will be installed in the JSI Key automotive track (1).
4. This process to can duplicated to add up to (2) drivers per vehicle.
5. Each new, scanned print and driver will be designated as (e) print two and three on the JSI Key automotive track.
6. Finally the JSI Automotive application can be turned-off with the primary driver approval for short-term driver such as valet services or mechanical services.
7. See FIG. (1) the JSI Biometric Key:
8. Cross Reference Application 11-900-118
9. See FIG. (2) JSI Biometric Automotive Application

JSI-BIOMETRIC KEY &
BIOMETRIC AUTOMOTIVE APPLICATON

| FIG. | |
|---|---|
| (1) | BIOMETRIC KEY |
| 10 | Biometric Key designed to prevent point of sales, vehicle |
| | thefts and provide entry access to high value assets or |
| | areas. Cross Reference Application 11-900-118 |
| 20 | Whole for carrying the biometric key on a key ring. |
| 30 | Chip Recognition System-System on a chip (CRS) |
| | designed to identify each landscape the biometric key can |
| | operate and provide access to; point of sales, automotive |
| | entry access. |
| 40 | Connectors that request, send and receive electrical signals |
| | to confirm and validate a stored finger print or hand print |
| | on a biometric chip or storage device. |
| 50 | Track (1) Point of sales: In this area the end user can store |
| | up to (8) credit or merchant card numbers, checking and |
| | debit card data, personal information, drivers' license, |
| | address. |
| 60 | Track (2) Vehicle/Auto: Provide up to (3) drivers secure |
| | biometric access to a vehicle to prevent theft. |
| 70 | USB connector to connect the biometric key to the |
| | designated landscape and provide the required data. |
| 80 | Track (3) Residential facility Access unit with up to |
| | (8) Biometric Identification Surface Pads. BISP. |
| 85 | Active light indicator to identify the key is properly |
| | working in each landscape; POS, AUTO, RESIDENTIAL. |
| 90 | Finger print/Hand Print chip for storing prints and |
| | verifying the designated owner. |

| FIGS. | |
|---|---|
| (1) & (2) | BIOMETRIC VEHICLE ELECTRICAL SCANNER |
| 180 | Vehicle steering wheel. |
| 185 | The JSI Biometric Key |
| | Cross-Reference application 11-900-118. |
| | FIG. (1). |
| 190 | Key insertion point (ignition). For the JSI Key |
| 200 | Scanner On-Off-Delete switch. |
| 210 | Finger print scanner: scan prints and store images in the |
| | vehicle electrical system and print confirmation panel. |
| 220 | Print confirmation panel that retains up to 3 drivers finger |
| | prints. |
| 230 | Internal control panel: gas, lights, speed, temperature. |
| 240 | Ten second driver confirmation with biometric print. |
| | Confirmed Authorized Driver (CAD) |

### CROSS-REFERENCE TO RELATED APPLICATION

1. JSI Key
Application number -11-900-118.
2. JSI Biometric Point of Sales Application
Application number -60-999-1117
3. JSI Biometric Automotive Application (BVES)
Application number-61-191-041
4. JSI Biometric Residential and Facility Access Unit
Application number 61-191-042

### STATEMENT REGARDING FEDERALLY SPONSORED RESEARCH OR DEVELOPMENT

No federally sponsored research is associated with this patent application.

### REFERENCE TO SEQUENCE LISTING, A TABLE OR A COMPUTER PROGRAM LISTING COMPACT DISC APPENDIX

Not applicable for this product

### BACKGROUND OF THE INVENTION

After spending several years in consumer research and behavior, automotive and identity theft and security applications Jstone Indurties (JSI) designed a multi-functional biometric base product that will prevent auto theft. The JSI Automotive Biometric Electrical Scanner working in conjunction with the JSI Key can biometrically secure a vehicle, and can provide up to three biometric authorized drivers and provide an additional security feature called driver confirmation.

The automotive industry is presently adding new product and technologies to their vehicles such blue tooth, touch to talk, satellite radio and televisions and other highly values assets. In order to protect these assets and increase the value of their vehicle the JSI Biometric Electrical Scanner and its BISP—Biometric Identification Surface Pads can biometrically secure the vehicle and all of its internal assets.

Automotive or vehicle security has been strategically ignored by the industry in the area of preventing vehicle theft. The external security number codes on the vehicle and remote wireless applications can all be easy broken and the vehicle stolen. The most recent and widely used theft application in the industry addresses theft after the vehicle has been stolen, such as on board and satellite tracking devices, which is some cases the devices can be removed from the vehicle. The JSI Biometric Electronic Scanner can prevent vehicle theft and only designated individual (s) will have access and control to vehicle with the JSI automotive application.

The JSI Automotive application is an integral and supporting part of the JSI Key biometric system integration process. In the automotive application this process and technology will prevent a vehicle from being stolen and prevent unauthorized drivers from driving the vehicle. The JSI Biometric scanner is designed technically and aesthetically to be integrated into the steering column with drivers' symbols or (e) print symbols appearing the vehicle control panel.

### BRIEF SUMMARY OF THE INVENTION

The JSI Automotive application working in conjunction with the JSI Key will prevent a vehicle from being stolen or used by an unauthorized driver. The JSI automotive application is a biometric based and it gives the owner of the vehicle the ability to authorize two other people to drive their car. The JSI automotive application use (e) print biometric technology therefore, if your prints are not stored in the vehicle electrical system under norm circumstances you would not be allowed to drive the vehicle.

The owner can enable or disable the (e) print technology for short periods of time for items such valet service or mechanical services. If the (e) print is disable for more than the designated time the vehicle will automatically revert back to its' default setting to the primary driver.

### BRIEF DESCRIPTION OF SEVERAL VIEWS OF THE DRAWING

From a seated position in vehicle behind the steering wheel looking directly forward the driver can see the JSI-Automotive Application (BVES) Biometric Vehicle Electronic Scanner on top of the steering wheel. On the right side of the steering wheel is the insertion point (ignition) for the JSI Key. Directly in front of the driver is the control panel. Once a print is scanned into the electrical system (D1-primary driver symbol) will appear in the print confirmation panel. This process can be repeated driver 2 & 3.

### 1. See FIG. (1) the JSI Biometric Key:

### 2. Cross Reference Application 11-900-118

### 3. See FIG. (2) JSI Biometric Automotive Application

### DETAILED DESCRIPTION OF THE INVENTION

The JSI Automotive Biometric Scanner is a scaled down version of the biometric scanner that is used in all the JSI applications which includes the point of sales application, automotive and (BISP) technology, and the entry access applications.

The Automotive Biometric/Fingerprint Scanner dimensions are (1×1) inch and (0.50) inch in dept the finger print scanner is integrated into steering column on the top side and the prints are scan into the vehicle's electrical system from the scanner and appears in the vehicle print confirmation panel (D1) (D2) a (D3) thus having 3 designated drivers per vehicle.

The JSI Biometric Electrical Scanner has a 1 MB of memory storage for retaining the owner left or right index finger or his or her left or right thumb for the biometric scanner to install their prints into the electrical system. The print approval and driver indicator light or designated symbols are located in the print confirmation panel in the following Primary Driver (D1), Second Driver (D2), Final Driver (D3) Below is a picture of the JSI Biometric Automotive scanner that is built into the surface area of the steering column and is connected into the vehicle electrical system. (FIG. 2)

As a stand alone the product the JSI Biometric Automotive Scanner that is integrated into the steering column is made in the following steps. small sheets of polyvinyl chloride acetated plastic that are molded in shape into a (1×1) dimension with an optical infrared Fingerprint Sensor.

### Memory: Flash Memory 1 MB

JSI—Biometric reader and scanning software

### Standard I/O Configurations

### Security: DES, 3DES, RSA, Master/Session, DUKPT

### Weight: 2 lbs

Connectivity: Hardware USB supported with cables.

### Enrollment Method Single Finger, Multi-Touch Enrollment

JSI Automotive Biometric Scanner:

### External—(Outside the Vehicle)

### BISP—Size (1×1) Biometric Identification Surface Pad

Built into the exterior structure of the door are the (BISPs) providing the owner the option to use the BISP technology to access the car or vehicle using the scan print that is in the vehicle electrical system.
The (BISP) consist of a soft biometric sensory around door frame area, or the doors can open through a remote access.

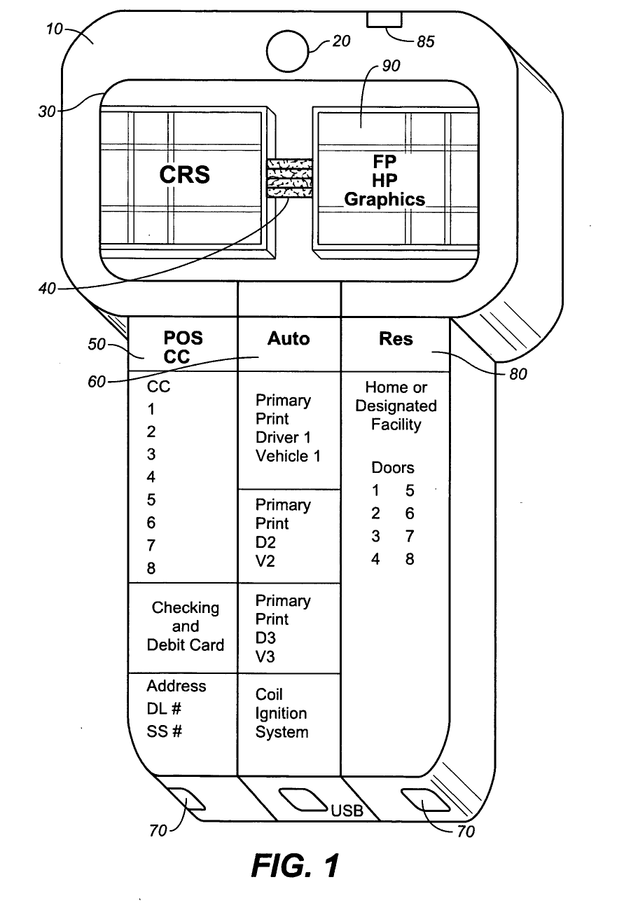

The JSI Automotive Application is designed to work in conjunction with the JSI Key to prevent auto thefts and determine who is authorize to drive the designated vehicle. Upon entering a designated vehicle that has the JSI automotive application the owner will take their JSI Key and insert it into the ignition if this a first time user the following steps are required to be taken.
1. The owner will insert their JSI Key into the vehicle ignition system.
2. The Chip Recognition System in the JSI Key will recognize the automotive electrical system and ask the user to install the designated driver (e) prints.
3. At that point the owner will take their left or right index finger or thumb and place it on the JSI infrared biometric scanner and the scanner will scan the print into the vehicle electrical system as (e) print (1) and that designated driver and that print will have access to the vehicle ignition system and the (BISP) Biometric Identification Surface Pads to access the vehicle doors. At the same time the biometric scanner will send a scanned copy of the print to the JSI Key and that print will be installed in the JSI Key automotive track (1).
4. This process to can duplicated to add up to (2) drivers for that vehicle and the prints can be assigned to auto track 2 and auto track 3.
5. Each new scanned print and driver will be designated as (e) print two and three on the JSI Key automotive track.
6. Finally the JSI Automotive application can be turned-off with the primary driver approval for short-term driver such as valet services or mechanical services.
7. See Drawing FIGS. 1 and 2

Working in conjunction with The JSI Key the JSI Biometric Automotive application can read, scan, and send biometric fingerprint to a vehicle electrical system that appears in the control panel in the print confirmation center as

### (1) Primary Driver; (D1)

### (2) Secondary Driver (D2)

### (3) Final Driver (D3)

This biometric print is stored in the electrical system and on a JSI biometric key on the auto track. See FIG. (2) number 220

### Dr: Formal Drawings

See number listing and FIGS. 1 and 2.

JSI-BIOMETRIC KEY &
BIOMETRIC AUTOMOTIVE APPLICATON

| FIG. | |
|---|---|
| (1) | BIOMETRIC KEY |
| 10 | Biometric Key designed to prevent point of sales, vehicle |
| | thefts and provide entry access to high value assets or |
| | areas. Cross Reference Application 11-900-118 |
| 20 | Whole for carrying the biometric key on a key ring. |
| 30 | Chip Recognition System-System on a chip (CRS) |
| | designed to identify each landscape the biometric key can |
| | operate and provide access to; point of sales, automotive |
| | entry access. |
| 40 | Connectors that request, send and receive electrical signals |
| | to confirm and validate a stored finger print or hand print |
| | on a biometric chip or storage device. |
| 50 | Track (1) Point of sales: In this area the end user can store |
| | up to (8) credit or merchant card numbers, checking and |
| | debit card data, personal information, drivers' license, |
| | address. |
| 60 | Track (2) Vehicle/Auto: Provide up to (3) drivers secure |
| | biometric access to a vehicle to prevent theft. |
| 70 | USB connector to connect the biometric key to the |
| | designated landscape and provide the required data. |
| 80 | Track (3) Residential facility Access unit with up to |
| | (8) Biometric Identification Surface Pads. BISP. |
| 85 | Active light indicator to identify the key is properly |
| | working in each landscape; POS, AUTO, RESIDENTIAL. |
| 90 | Finger print/Hand Print chip for storing prints and |
| | verifying the designated owner. |

| FIGS. | |
|---|---|
| (1) & (2) | BIOMETRIC VEHICLE ELECTRICAL SCANNER |
| 180 | Vehicle steering wheel. |
| 185 | The JSI Biometric Key |
| | Cross-Reference application 11-900-118. |
| | FIG. (1). |
| 190 | Key insertion point (ignition). For the JSI Key |
| 200 | Scanner On-Off-Delete switch. |
| 210 | Finger print scanner: scan prints and store images in the |
| | vehicle electrical system and print confirmation panel. |
| 220 | Print confirmation panel that retains up to 3 drivers finger |
| | prints. |
| 230 | Internal control panel: gas, lights, speed, temperature. |
| 240 | Ten second driver confirmation with biometric print. |
| | Confirmed Authorized Driver (CAD) |

1. Working in conjunction with The JSI Key the JSI Biometric Vehicle Electrical Scanner can read, enroll and send biometric fingerprint to a vehicle electrical system that will appears in the print confirmation panel as Track One Primary Driver (D1), Track 2 Secondary Driver (D2), and Track 3 (D3) Final Driver. After a print has been confirmed the vehicle will start. The JSI Automotive application can prevent vehicle thefts by unauthorized drivers by using its biometric technology and its 10 second driver confirmation notice.
